(19) United States
(12) Patent Application Publication
(10) Pub. No.: US 2008/0246696 A1
(43) Pub. Date: Oct. 9, 2008

(54) Plasma display and driving device thereof

(76) Inventor: Jin-Ho Yang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/011,717

(22) Filed: Jan. 28, 2008

(30) Foreign Application Priority Data
Apr. 9, 2007 (KR) 10-2007-0034670

(51) Int. Cl. G09G 3/28

(52) U.S. Cl. 345/68

(57) ABSTRACT

A driver circuit for a scan electrode of a plasma display panel is disclosed. The driver circuit has reduced voltage drop in the current path used to drive the scan electrode during a sustain period. Accordingly, the circuit provides improved power efficiency and speed.

### CROSS-REFERENCE TO RELATED APPLICATION

This application claims priority to and the benefit of Korean Patent Application No. 10-2007-0034670 filed in the Korean Intellectual Property Office on Apr. 9, 2007, the entire contents of which are incorporated herein by reference.

### BACKGROUND

1. Field

The field relates to a plasma display and a driver thereof.

2. Description of Related Technology

A plasma display panel (PDP) is a flat panel display that uses plasma generated by gas discharge to display characters or images. It includes, depending on its size, more than several scores to millions of pixels arranged in a matrix pattern. In the PDP, a plurality of scan electrodes and a plurality of sustain electrodes are formed in pairs in a row direction, and a plurality of address electrodes are formed in a column direction. In general, one frame of the plasma display is divided into a plurality of subfields when driving the plasma display. Turn-on/turn-off cells (i.e., cells to be turned on or off) are selected during an address period of each subfield, and a sustain discharge operation is performed on the turn-on cells so as to display an image during a sustain period. Grayscales are expressed by a combination of weights of the subfields that are used to perform the display operation.

Accordingly, to perform the display operation, a scan pulse is selectively applied to the plurality of scan electrodes during the address period, and a sustain pulse alternately having a high level voltage and a low level voltage is applied to the plurality of scan and sustain electrodes performing a sustain discharge during the sustain period. Since the two electrodes in which the sustain discharge is generated function as a capacitive component, reactive power is required to apply the high and low level voltages to the plurality of scan electrodes. A large number of transistors are formed in a driving circuit to drive the scan electrodes in the plasma display. For example, first and second transistors for respectively applying the high and low level voltages to the plurality of scan electrodes are connected to the scan electrode, and an energy recovery circuit for recovering reactive power during the sustain period is connected to an node of the first and second transistors. The energy recovery circuit includes a third transistor for gradually increasing a voltage at the plurality of scan electrodes to be close to the high level voltage and a fourth transistor for gradually decreasing the voltage at the plurality of scan electrodes to the low level voltage. A conventional energy recovery circuit has been disclosed in U.S. Pat. No. 4,866,349 and No. 5,081,400 by L. F. Weber. In addition, a fifth transistor for sequentially applying the scan pulse to the plurality of scan electrodes during the address period is connected to the plurality of scan electrodes, and a sixth transistor for interrupting a current path formed through a body diode of the second transistor when the fifth transistor is turned on is connected between the second transistor and the fifth transistor. That is, the sixth transistor is provided to each current path for applying the high level voltage and the low level voltage to the scan electrode during the sustain period. In addition, since each current path includes other transistors and elements, a considerable voltage drop may be generated, and therefore the sustain pulse may be distorted.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display including an electrode, a first transistor including a first terminal connected to the electrode, a second transistor connected between a second terminal of the first transistor and a first power source configured to supply a first voltage, a third transistor connected between a first terminal of the second transistor and a second power source configured to supply a second voltage, where the second voltage is less than the first voltage, a capacitor charged with a third voltage that is greater than the first voltage, and a first path that is connected between the capacitor and the first terminal of the first transistor. The first path is configured to vary the voltage at the electrode during a sustain period before the second transistor is turned on.

Another aspect is a plasma display including an electrode, a first path including a first inductor connected between an energy recovery power source and the electrode, the first path configured to supply a voltage to the electrode and to increase the voltage at the electrode through the first inductor. The display also includes a second path including a second inductor connected between the energy recovery power source and the electrode, the second path configured to decrease the voltage at the electrode through the second inductor, where the number of circuit elements included in the first path is less than the number of circuit elements included in the second path.

Another aspect is a driver of a plasma display including an electrode. The driver includes a capacitor, a first transistor including a first terminal and a second terminal that are respectively connected between the capacitor and the electrode, a first inductor connected between the capacitor and the first terminal of the first transistor, a second inductor connected between the capacitor and the second terminal of the first transistor, a second transistor connecting the capacitor and the first inductor, and forming a path for decreasing a voltage at the electrode, and a third transistor connecting the capacitor and the second inductor, and forming a path for increasing the voltage at the electrode.

### BRIEF DESCRIPTION OF THE DRAWINGS

FIG. 1 is a schematic diagram of the plasma display according to tone embodiment.

FIG. 2 is a diagram representing driving waveforms of the plasma display.

FIG. 3 is a diagram of a scan electrode driving circuit according to one embodiment.

FIG. 4A to FIG. 4E respectively show diagrams representing current paths according to the operation of an embodiment of the scan electrode driving circuit.

FIG. 5 is a diagram of the scan electrode driving circuit according to another embodiment.

### DETAILED DESCRIPTION OF CERTAIN INVENTIVE EMBODIMENTS

In the following detailed description, only certain embodiments have been shown and described, simply by way of illustration. As those skilled in the art would realize, the described embodiments may be modified in various ways, without departing from the spirit or scope of the present invention.

Accordingly, the drawings and description are to be regarded as illustrative in nature and not restrictive. Like reference numerals generally designate like elements throughout the specification. When it is described that an element is coupled to another element, the element may be directly coupled to the other element or coupled to the other element through a third element.

When it is described in the specification that a voltage is maintained, it should not be understood to strictly imply that the voltage is maintained exactly at a predetermined voltage. To the contrary, if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art in the context of the discussion. In addition, since threshold voltages of semiconductor elements (e.g., a transistor and a diode) are very low compared to a discharge voltage, they are considered to be substantially 0V. Thus, in some cases, voltages applied to a node or an electrode by a power source includes voltages changed due to a threshold voltage or a parasitic component, etc., from voltage of the power source voltage.

A plasma display according to one embodiment will be described.

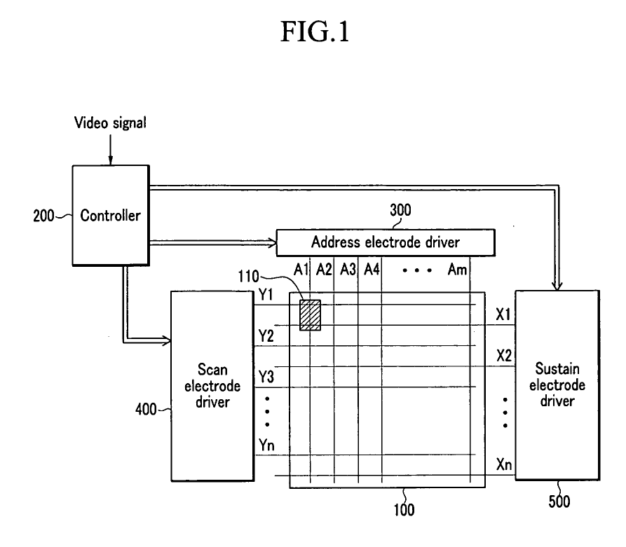

FIG. 1 is a schematic diagram of the plasma display according to one embodiment.

As shown in FIG. 1, the plasma display includes a plasma display panel (PDP) 100, a controller 200, an address electrode driver 300, a scan electrode driver 400, and a sustain electrode driver 500.

The plasma display panel (PDP) 100 includes a plurality of address electrodes A1 to Am (referred to as ‘A electrodes’ hereinafter) extending in a column direction, and a plurality of sustain electrodes X1 to Xn (referred to as ‘X electrodes’ hereinafter) and a plurality of scan electrodes Y1 to Yn (referred to as ‘Y electrodes hereinafter) extending in a row direction, the X and Y electrodes making pairs. In general, the X electrodes X1 to Xn are formed to correspond to the respective Y electrodes Y1 to Yn, and the X electrodes X1 to Xn and the Y electrodes Y1 to Yn perform a display operation during a sustain period in order to display an image. The Y electrodes Y1 to Yn and the X electrodes X1 to Xn are disposed to cross the A electrodes A1 to Am. Discharge spaces formed at each crossing of the A electrodes A1 to Am and the X and Y electrodes X1 to Xn and Y1 to Yn form cells 110. The PDP 100 shows one embodiment, and a panel to which subsequent driving waveforms are applicable can be applied to PDP 100 as well as other embodiments.

The controller 200 receives an external video signal and outputs an A electrode driving control signal, an X electrode driving control signal, and a Y electrode driving control signal. In addition, the controller 200 divides one frame into a plurality of subfields.

The address electrode driver 300 applies a driving voltage to the plurality of A electrodes A1 to Am according to the driving control signal from the controller 200.

The scan electrode driver 400 applies a driving voltage to the plurality of Y electrodes Y1 to Yn according to the driving control signal from the controller 200.

The sustain electrode driver 500 applies a driving voltage to the plurality of X electrodes X1 to Xn according to the driving control signal from the controller 200.

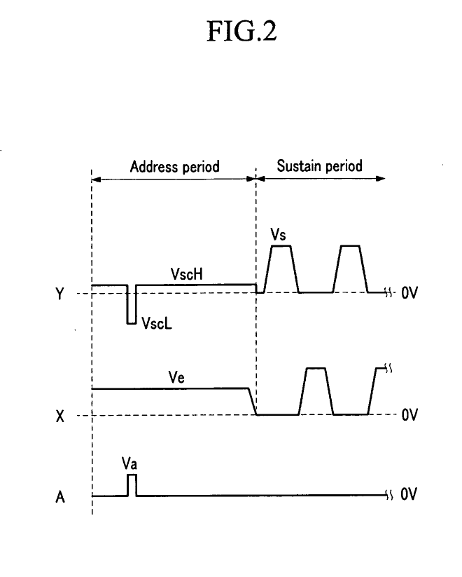

FIG. 2 is a diagram representing driving waveforms of the plasma display. In FIG. 2, the driving waveform of one subfield among a plurality of subfields forming one frame is illustrated, and the driving waveform applied to the X, Y, and A electrodes forming one discharge cell is illustrated.

As shown in FIG. 2, to select a turn-on cell during the address period, the scan electrode driver 400 applies a scan pulse having a VscL voltage to the Y electrode while the sustain electrode driver 500 maintains a voltage at the X electrode X to be a Ve voltage. In this case, the address electrode driver 300 applies an address pulse having a Va voltage to the A electrode A crossing the turn-on cell of the plurality of cells formed by the Y electrode receiving the VscL voltage and the X electrode X, and a 0V voltage that is lower than the Va voltage to the A electrode passing through a turn-off cell. An address discharge is generated between the A electrode A receiving the Va voltage and the Y electrode Y receiving the VscL voltage and between the Y electrode receiving the VscL voltage and the X electrode X receiving the Ve voltage. Positive (+) wall charges are formed on the Y electrode Y, and negative (−) wall charges are respectively formed on the X and A electrodes X and A. In addition, the scan electrode driver 400 applies a VscH voltage that is higher than the VscL voltage to the Y electrode to which the VscL voltage is not applied.

In further detail, during the address period, the scan electrode driver 400 and the address electrode driver 300 apply the scan pulse to a Y electrode in a first row (e.g. Y1 in FIG. 1) and simultaneously apply the address pulse to the A electrode positioned on the light emitting cell in the first row. Thereby, the address discharge is generated between the Y electrode in the first row and the A electrode receiving the address pulse, and the (+) wall charges are formed on the Y electrode, and the (−) wall charges are respectively formed on the A and X electrodes. Subsequently, while applying the scan pulse to the Y electrode in a second row (e.g. Y2 in FIG. 1), the scan electrode driver 400 and the address electrode driver 300 apply the address pulse to the A electrode positioned on the light emitting cell in the second row. Thereby, the address discharge is generated in the cell of the A electrode receiving the address pulse and the Y electrode in the second row, and wall charges are formed on the cell. In a like manner, while sequentially applying the scan pulse to the Y electrodes in remaining rows, the scan electrode driver 400 and the address electrode driver 300 apply the address pulse to the A electrodes positioned on the light emitting cell to form the wall charges.

During the sustain period, the scan electrode driver 400 applies a sustain pulse alternately having the high level voltage (Vs in FIG. 2) and the low level voltage (0V in FIG. 2) to the Y electrode a number of times corresponding to a weight value of the subfield. The sustain pulse applied to the X electrode by the sustain electrode driver 500 has an opposite phase to the sustain pulse applied to the Y electrode. Accordingly, a voltage difference between the Y electrode and the X electrode alternately has the Vs voltage and a −Vs voltage, and therefore the sustain discharge is repeatedly generated in the light emitting cell a predetermined number of times.

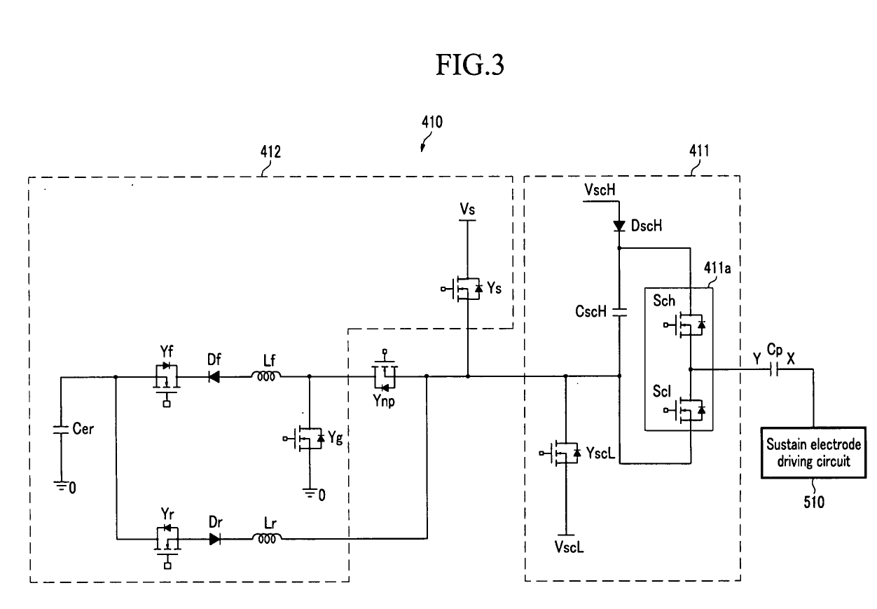

FIG. 3 is a diagram of a scan electrode driving circuit according to one embodiment. A scan electrode driving circuit 410 may be formed in the scan electrode driver 400, and a sustain electrode driving circuit 510 connected to the X electrode X may be formed in the sustain electrode driver 500. For better understanding and ease of description, one Y electrode Y is illustrated, and a capacitive component formed by one Y electrode Y and one X electrode X is illustrated as a panel capacitor Cp.

As shown in FIG. 3, the scan electrode driving circuit 410 includes a scan driver 411, a sustain driver 412, and a transistor Ynp. The scan driver 411 includes a scan circuit 411a, a transistor YscL, a diode DscH, and a capacitor CscH, and the sustain driver 412 includes transistors Yr, Yf, Ys, and Yg, inductors Lr and Lf, diodes Dr and Df, and a capacitor Cer. In FIG. 3, transistors Ys, Yr, Yf, Yg, YscL, Ynp, Sch, and Scl are illustrated as n-channel field effect transistors, particularly an n-channel metal oxide semiconductor (NMOS) transistor, and a body diode is formed from a source to a drain in the transistors Ys, Yr, Yf, Yg, YscL, Ynp, Sch, and Scl. In addition, other transistors having a function that is similar to the NMOS transistor may be used for the transistors Ys, Yr, Yf, Yg, YscL, Ynp, Sch, and Scl. If transistors Ys, Yr, Yf, Yg, YscL, Ynp, Sch, and Scl are formed as insulated gate bipolar transistors (IGBT), diodes are respectively coupled in parallel to the transistors Ys, Yr, Yf, Yg, YscL, Ynp, Sch, and Scl, the diodes each including an anode connected to the emitter terminal, and a cathode connected to the collector terminal. In addition, in FIG. 3, while the transistors Ys, Yr, Yf, Yg, YscL, Ynp, Sch, and Scl are respectively illustrated as a single transistor, the transistors Ys, Yr, Yf, Yg, YscL, Ynp, Sch, and Scl may be formed by a plurality of transistors coupled in parallel.

Firstly, the scan circuit 411a includes a first input terminal, a second input terminal, and an output terminal connected to the Y electrode Y, and selectively applies a voltage at the first input terminal and a voltage at the second input terminal to the corresponding Y electrode Y to select the turn-on cell during the address period. In FIG. 3, while one scan circuit 411a connected to the Y electrode is illustrated, the scan circuit 411a is respectively applied to the plurality of Y electrodes Y1 to Yn shown in FIG. 1. In addition, a number of scan circuits 411a may be formed as an integrated circuit, and therefore a plurality of output terminals of the integrated circuit may be respectively connected to a predetermined number of Y electrodes (e.g., Y1 to Yk, where k is an integer that is lower than n). The scan circuit 411a includes transistors Sch and Scl. A source of the transistor Sch and a drain of the transistor Scl are respectively connected to the Y electrode of the panel capacitor Cp. A drain of the transistor Sch is connected to the first input terminal, and a source of the transistor Scl is connected to the second input terminal. The first input terminal is connected to a power source VscH for supplying the VscH voltage, and a cathode of the diode DscH including an anode connected to the power source VscH is connected to the second input terminal. In addition, the capacitor CscH is connected between the first input terminal and the second input terminal. A drain of the transistor YscL is connected to the second input terminal and a source of the transistor YscL is connected to a power source VscL for supplying the VscL voltage. In this case, the transistor YscL is turned on during the address period to supply the VscL voltage to the second input terminal of the scan circuit 411a.

A source of the transistor Ynp is connected to the drain of the transistor YscL, a source of the transistor Ys, and a first terminal of the inductor Lr, and a drain of the transistor Ynp is connected to a first terminal of the inductor Lf and a drain of the transistor Yg. A source of the transistor Yg is connected to a ground terminal for supplying the 0V voltage that is the low level voltage of the sustain pulse, and a drain of the transistor Ys is connected to a power source Vs for supplying the Vs voltage. In this case, the transistor Ynp interrupts a current path formed through the body diode of the transistor Yg when the transistor YscL is turned on. An anode of the diode Dr including a cathode connected to a second terminal of the inductor Lr is connected to a source of the transistor Yr, and a drain of the transistor Yr is connected to the capacitor Cer that is an energy recovery power source. A cathode of the diode Df also having an anode connected to a second terminal of the inductor Lf is connected to a drain of the transistor Yf, and a source of the transistor Yf is connected to the capacitor Cer. In this case, the capacitor Cer supplies a voltage between the high level voltage Vs and the low level voltage 0V, and in some embodiments, supplies an intermediate voltage of about Vs/2 of the two voltages Vs and 0V. The diode Dr establishes a rising path for increasing the voltage at the Y electrode Y, and the diode Df establishes a falling path for decreasing the voltage at the Y electrode Y. In some embodiments, the transistors Yr and Yf have no body diode, and the diodes Dr and Df may be eliminated. In addition, positions of the diode Dr, the transistor Yr, and the inductor Lr may be changed, and positions of the diode Df, the transistor Yf, and the inductor Df may be changed.

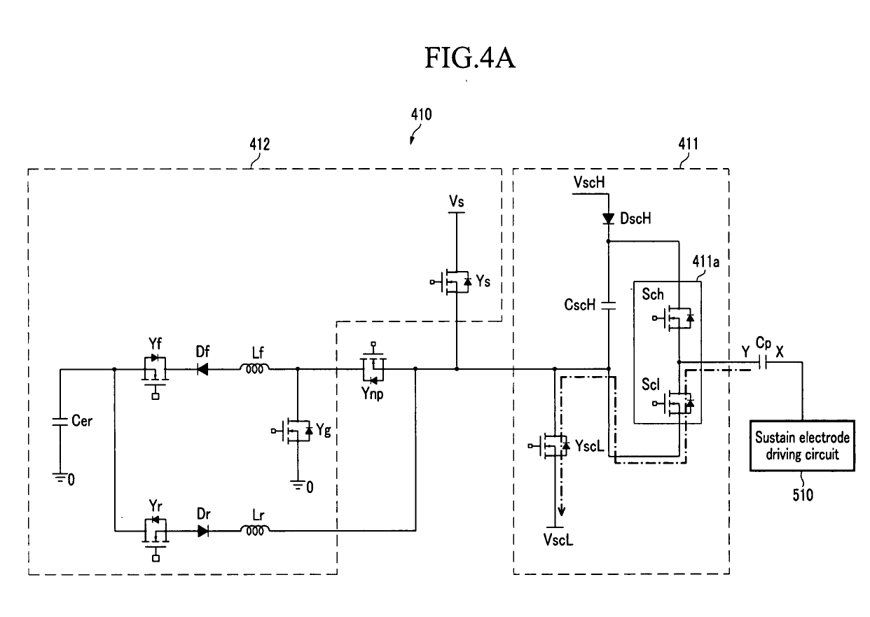

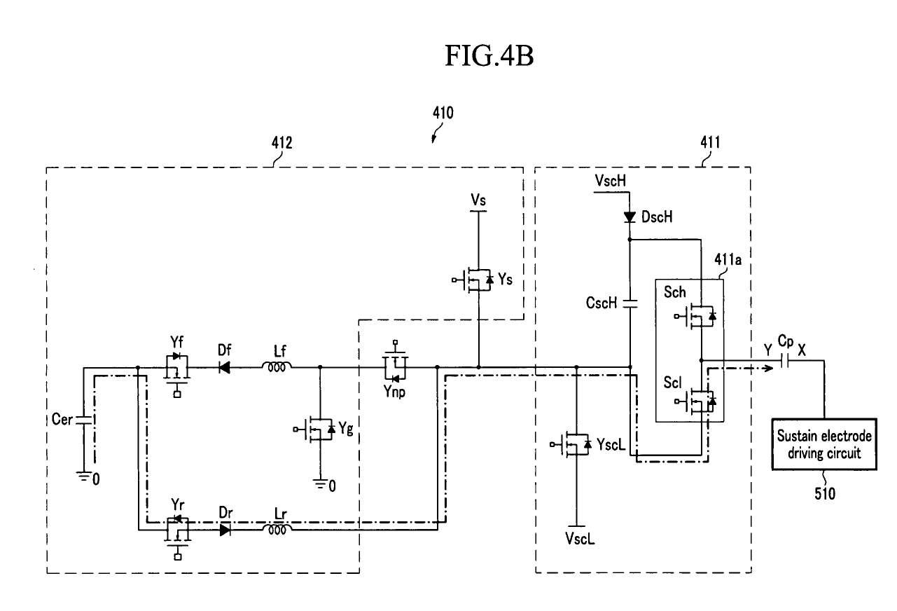

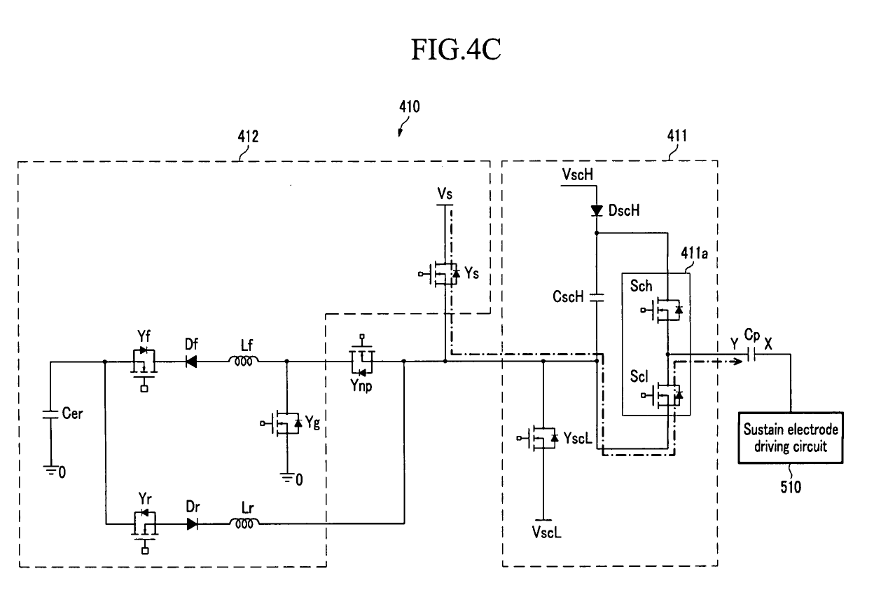

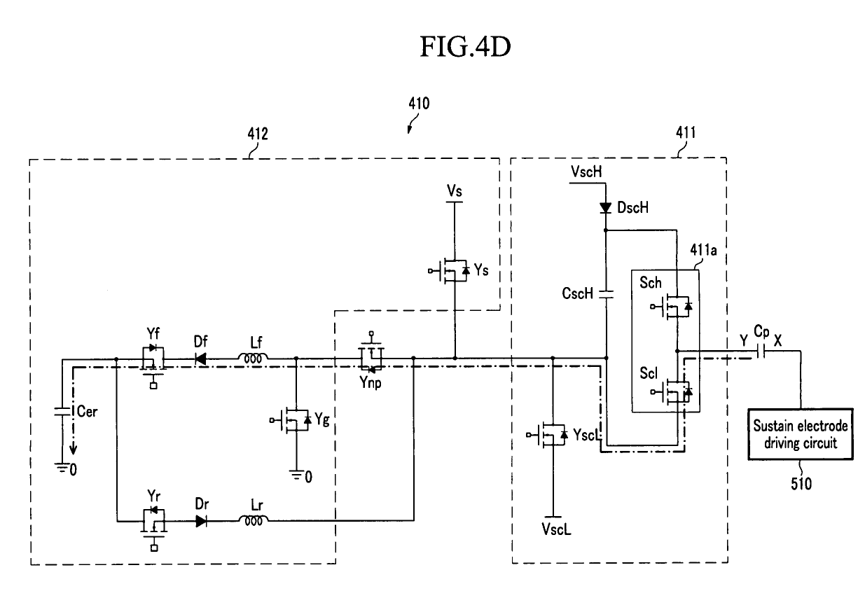

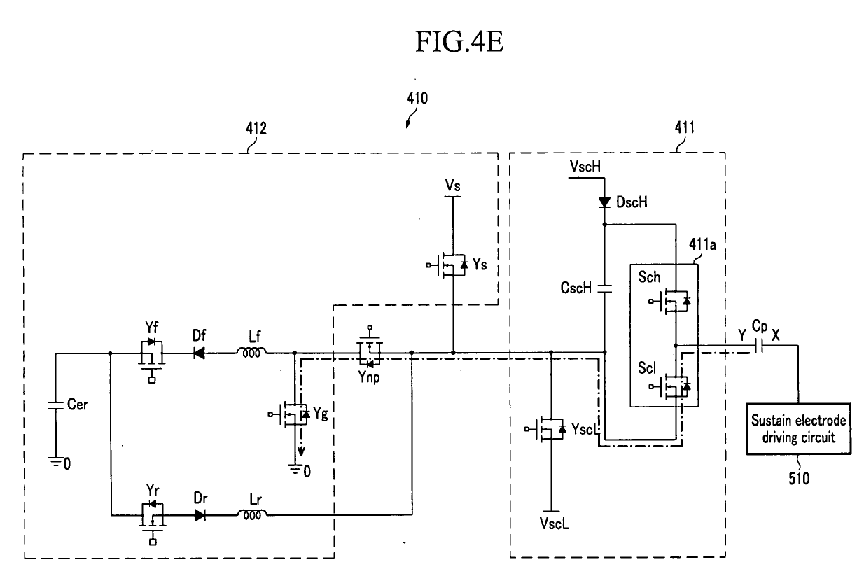

An operation of the scan electrode driving circuit shown in FIG. 3 will now be described with reference to FIG. 4A to FIG. 4E.

FIG. 4A to FIG. 4E respectively show diagrams representing current paths according to the operation of the scan electrode driving circuit.

Firstly, the transistor YscL is turned on during the address period. In this state, the transistors Sch and Scl are selectively turned on. When the transistor Scl is turned on, as shown in FIG. 4A, the VscL voltage is applied to the Y electrode through a path of the Y electrode Y, the transistors Scl and YscL, and the power source VscL. In this case, when the transistor Sch is turned on, the VscH voltage is applied to the Y electrode Y. In FIG. 4A, the transistor Scl is turned on.

During the sustain period, the transistor YscL is turned off and the transistor Yr is turned on. In addition, it is assumed that the 0V voltage is applied to the Y electrode before transistor Yr is turned on. Thereby, as shown in FIG. 4B, the voltage at the Y electrode increases since a resonance is generated through a path of the capacitor Cer, the transistor Yr, the diode Dr, the inductor Lr, the transistor Scl, and the Y electrode Y.

Subsequently, during the sustain period, the transistor Yr is turned off and the transistor Yr is turned on. Thereby, as shown in FIG. 4C, the Vs voltage is applied to the Y electrode through a path of the power source Vs, the transistors Ys and Scl, and the Y electrode Y.

Then, during the sustain period, the transistor Ys is turned off and the transistor Yf is turned on. Thereby, as shown in FIG. 4D, the voltage at the Y electrode decreases since the resonance is generated through a path of the Y electrode Y, the transistor Scl, the body diode of the transistor Ynp, the inductor Lf, the diode Df, the transistor Yf, and the capacitor Cer.

In addition, during the sustain period, the transistor Yf is turned off and the transistor Yg is turned on. Thereby, as shown in FIG. 4E, the 0V voltage is applied to the Y electrode through a path of the Y electrode Y, the transistor Scl, the body diode of the transistor Ynp, the transistor Yg, and the ground terminal.

Since the sustain driver 412 of the scan electrode driving circuit 410 repeatedly performs the operations shown in FIG. 4B to FIG. 4 a number of times corresponding to a weight value of the corresponding subfield, the sustain pulse alternately having the Vs voltage and the 0V voltage is applied to the Y electrode Y. In addition, since the current paths shown in FIG. 4B and FIG. 4C do not include the transistor Ynp, a voltage drop caused by the current flowing through the transistor Ynp may be avoided.

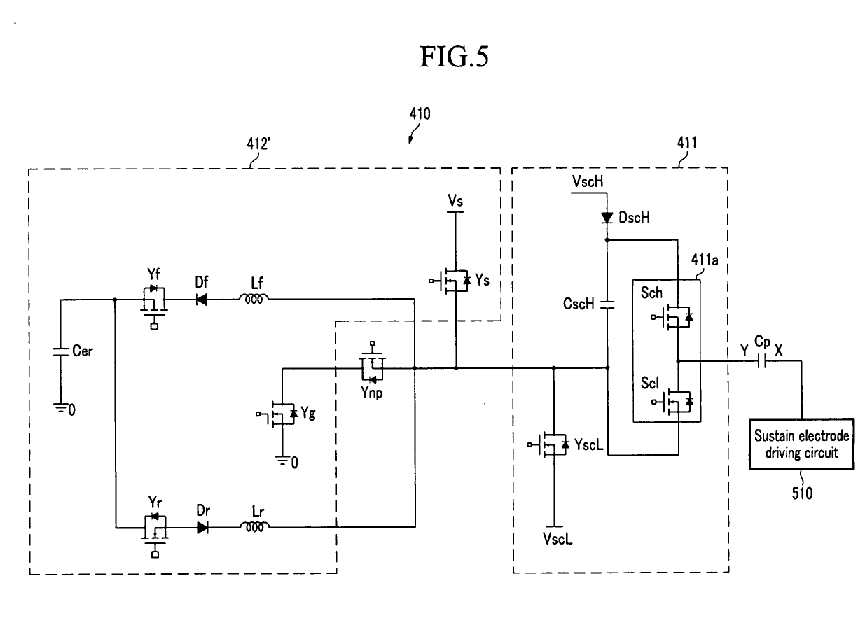

FIG. 5 is a diagram of the scan electrode driving circuit according to another embodiment.

As shown in FIG. 5, differing from the sustain driver 412 shown in FIG. 3, in a sustain driver 412′ of the scan electrode driving circuit 410, the first terminal of the inductor Lf is connected to the source of the transistor Ynp. Accordingly, during the sustain period, when the transistor Yf is turned on, the voltage at the Y electrode decreases since the resonance is generated through a path of the Y electrode Y, the transistor Scl, the inductor Lf, the diode Df, the transistor Yf, and the capacitor Cer. That is, differing from the current path shown in FIG. 4, the current path does not include the transistor Ynp. Accordingly, in the embodiment of FIG. 5, the voltage drop caused by the current flowing through the transistor Ynp is avoided.

While this invention has been described in connection with what is presently considered to be practical embodiments, it is to be understood that the invention is not limited to the disclosed embodiments, but, is intended to cover various modifications and equivalent arrangements included within the spirit and scope of the disclosed embodiments.

What is claimed is:

1. A plasma display comprising:
an electrode;
a first transistor including a first terminal connected to the electrode;
a second transistor connected between a second terminal of the first transistor and a first power source configured to supply a first voltage;
a third transistor connected between a first terminal of the second transistor and a second power source configured to supply a second voltage, wherein the second voltage is less than the first voltage;
a capacitor charged with a third voltage that is greater than the first voltage; and
a first path that is connected between the capacitor and the first terminal of the first transistor, the first path configured to vary the voltage at the electrode during a sustain period before the second transistor is turned on.

2. The plasma display of claim 1, further comprising a fourth transistor connected between the first terminal of the first transistor and a third power source configured to supply a fourth voltage, wherein the fourth voltage is greater than the first voltage,
wherein the third voltage is substantially the average of the fourth and first voltages.

3. The plasma display of claim 2, further comprising a second path, connected between the capacitor and the second terminal of the first transistor, the second path configured to vary the voltage at the electrode during the sustain period before the fourth transistor is turned on.

4. The plasma display of claim 3, wherein:
the first path comprises a first inductor, a first diode, and a fifth transistor connected in series between the capacitor and the first terminal of the first transistor; and
the second path comprises a second inductor, a second diode, and a sixth transistor connected in series between the capacitor and the second terminal of the first transistor.

5. The plasma display of claim 2, further comprising a second path between the capacitor and the first terminal of the first transistor, the second path configured to vary the voltage at the electrode during the sustain period before the fourth transistor is turned on.

6. The plasma display of claim 5, wherein:
the first path comprises a first inductor, a first diode, and a fifth transistor connected in series between the capacitor and the first terminal of the first transistor; and
the second path comprises a second inductor, a second diode, and a sixth transistor connected in series between the capacitor and the first terminal of the first transistor.

7. The plasma display of claim 3, further comprising a diode including an anode connected to the first terminal of the first transistor and a cathode connected to the second terminal of the first transistor, wherein the first transistor is an insulated gate bipolar transistor (IGBT).

8. The plasma display of claim 3, wherein the first transistor includes a body diode formed in a direction from the first terminal to the second terminal.

9. The plasma display of claim 1, wherein the electrode comprises a scan electrode.

10. A plasma display comprising:
an electrode;
a first path including a first inductor connected between an energy recovery power source and the electrode, the first path configured to supply a voltage to the electrode, and to increase the voltage at the electrode through the first inductor; and
a second path including a second inductor connected between the energy recovery power source and the electrode, the second path configured to decrease the voltage at the electrode through the second inductor,
wherein the number of circuit elements included in the first path is less than the number of circuit elements included in the second path.

11. The plasma display of claim 10, further comprising:
a first transistor connected between the electrode and a first power source for supplying a first voltage; and
a second transistor connected between the electrode and a second power source for supplying a second voltage, wherein the second voltage is less than the first voltage,
wherein the second current path includes a third transistor including a first terminal connected to the first transistor and a second terminal connected to the second transistor.

12. The plasma display of claim 11, further comprising a fourth transistor connected between the second terminal of the third transistor and a third power source for supplying a third voltage, wherein the third voltage is greater than the first voltage.

13. The plasma display of claim 12, wherein
the first path further comprises a fifth transistor connected between the energy recovery power source and the first inductor or between the first inductor and the electrode, and
the second path further comprises a sixth transistor connected between the energy recovery power source and the second inductor or between the second inductor and the first terminal of the third transistor.

14. The plasma display of claim 10, wherein the electrode comprises a scan electrode.

15. The plasma display of claim 10, wherein the energy recovery power source comprises a capacitor.

16. A driver of a plasma display comprising an electrode, the driver comprising:
a capacitor;
a first transistor including a first terminal and a second terminal that are respectively connected between the capacitor and the electrode;
a first inductor connected between the capacitor and the first terminal of the first transistor;
a second inductor connected between the capacitor and the second terminal of the first transistor;
a second transistor connecting the capacitor and the first inductor, and forming a path for decreasing a voltage at the electrode; and
a third transistor connecting the capacitor and the second inductor, and forming a path for increasing the voltage at the electrode.

17. The driver of claim 16, further comprising a fourth transistor connected between a first power source for supplying a first voltage and the second terminal of the first transistor.

18. The driver of claim 17, further comprising:
a fifth transistor connected between a second power source configured to supply a second voltage and the first terminal of the first transistor, wherein the second voltage is lower than the first voltage; and
a sixth transistor connected between a third power source configured to supply a third voltage and the second terminal of the first transistor, wherein the third voltage is less than the second voltage.

19. The driver of claim 18, further configured to apply the first and second voltages to the electrode during a sustain period, to apply the third voltage to the electrode during an address period, and to apply charge a voltage between the first and second voltages in the capacitor.

20. The plasma display of claim 16, wherein the electrode comprises a scan electrode.
